(19) United States
(12) Patent Application Publication
(10) Pub. No.: US 2011/0276174 A1
(43) Pub. Date: Nov. 10, 2011

(54) PALLETIZER MACHINE AND METHOD OF PALLETIZING

(75) Inventors: Dante Bolzani, Traversetolo (IT); Vittorio Cavirani, Traversetolo (IT)

(73) Assignee: ELETTRIC 80 S.P.A., Viano (IT)

(21) Appl. No.: 13/144,898

(22) PCT Filed: Jan. 14, 2010
(86) PCT No.: PCT/IB10/50155

§ 371 Date: Jul. 20, 2011

(30) Foreign Application Priority Data
Jan. 16, 2009 (EP) 09000542.2

(51) Int. Cl. B65G 57/24; G06F 17/00

(52) U.S. Cl. 700/217; 414/789.8; 414/802; 901/31

(57) ABSTRACT

A palletizer machine and a method for palletizing layers, one on top of the other, of packs fed from an infeed transfer line includes a transfer unit for transferring single packs arriving from the line to a first operating position, a forming unit for feeding single packs from the operating position to a predefined forming position wherein a layer of packs is formed on a loading platform, a loading unit for transferring the layer of packs on the loading platform to a pick-up station, and a robot for picking up the layer from the pick-up station and forming a palletized load of layers one on top of the other.

### TECHNICAL FIELD

The present invention relates to a palletizer machine and in particular to a palletizer machine for the beverage sector, that is, equipment for palletizing groups of bottles or containers.

### BACKGROUND ART

Known technology for this purpose has for some time included machines based on the transfer on conveyor belts of successive groups of bottles or containers hereinafter referred to as ‘packs’.

In systems of the known type, the packs are made to travel along feed lines and are carried to ordering devices which form rows of packs.

The rows formed in this way are positioned and aligned by pushers so as to form pack layers which are then placed one on top of the other to form the palletized load ready for wrapping or capping.

One drawback of known systems is the need to transfer and to partially and dynamically manipulate the packs. Transfer causes friction and rubbing and manipulation can cause jamming of the packs during transfer. This damages the product before it is palletized, and prevents the formation of a correct load geometry.

This means that the packs have to be forced into the final configuration specified for the layer and this can modify in an unwanted way the geometry of the layer, or even more seriously, alters the overall shape of the layer being formed.

### SUMMARY OF THE INVENTION

The aim of the present invention is to overcome the drawbacks of known solutions and to provide a compact-size, high-speed palletizer machine.

A second aim of the present invention is to provide a high-productivity method of palletizing which enables constant dynamic handling, that is, preforming of the packs with positive action thereby eliminating the risk of damage.

A further aim of the present invention is to provide a method of palletizing which enables inspection of the equipment even during the operating cycle.

Another aim of the present invention is to provide a method of palletizing which enables operator interventions and cycle resetting in any cycle step without having to zero set the cycle and eject all the product from the area.

These aims are achieved by a palletizer machine and a method of palletizing according to the main claims below.

A first advantage of the invention is that the compact, fast equipment proposed eliminates those drawbacks of the background art relating to the pack damage caused by rotating the packs and at the same time guarantees high productivity rates.

### BRIEF DESCRIPTION OF THE DRAWINGS

These and further advantages will be more clearly understood by a technical expert in this field from the description which follows and from the appended drawings provided merely by way of example without restricting the scope of the inventive concept and in which:

FIG. 1 shows a side view of a palletizer machine according to the present invention.

FIGS. 2a, 2b and 2c show respectively a side view, a front view and a plan view of a transfer unit of a palletizer machine according to the present invention.

FIGS. 3a, 3b and 3c show respectively a side view, a front view and a plan view of a forming unit of a palletizer machine according to the present invention.

FIGS. 4a and 4b show respectively a side view and a front view of a loading unit of a palletizer machine according to the present invention.

FIG. 5 shows a plan view of the forming and loading zone of the palletizer machine in FIG. 1.

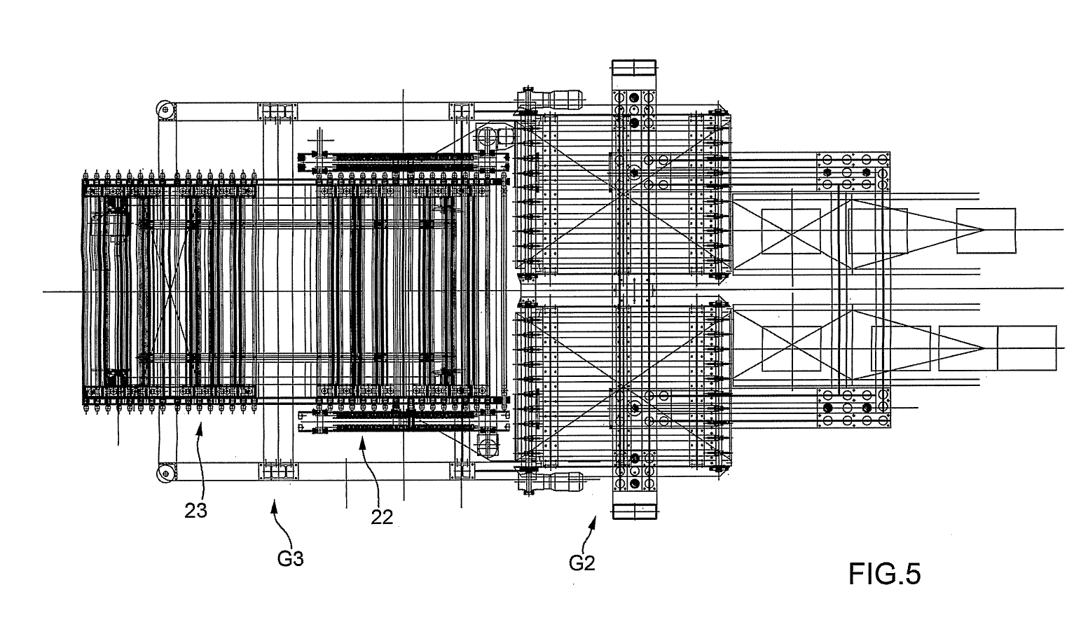

FIGS. 6a to 6d show respectively a side view, a front view, a plan view and an enlarged mechanical detail of the programming unit of the loading unit in 4a and 4b.

FIGS. 7a to 7d show respectively a side view, a front view, a plan view and an enlarged mechanical detail of the loader device of the loading unit in FIGS. 4a and 4b.

FIGS. 8a, 8b and 8c show the sequence of cycle steps of a pick-up head according to the present invention, respectively in a side view, a front view and a top view.

FIG. 9 shows the sequence of steps according to the present invention for forming the pack layers and palletizing the formed layers.

FIG. 10 shows a plan view of another embodiment of a palletizer machine according to the present invention.

FIG. 11 shows a plan view of a further embodiment of a palletizer according to the present invention.

FIG. 13 shows a front view of the palletizer machine in FIGS. 11 and 12;

FIG. 13A is a detail of FIG. 13;

FIGS. 14A to 14F show detailed side views of the operating cycle steps of the palletizer machine of the embodiment shown in FIGS. 11 to 13.

FIG. 15 is side view of yet a further embodiment of the palletizer machine according to the present invention.

### DETAILED DESCRIPTION OF PREFERRED EMBODIMENTS

With reference to the accompanying figures, a palletizer machine according to an exemplary aspect of the present invention comprises:

a transfer unit for transferring the single packs arriving from an infeed line to a first operating position,

a forming unit for feeding the packs forward from position to a predefined loading position for forming layers of packs on a loading platform,

a loading unit for transferring the formed layers to a pick-up station, and

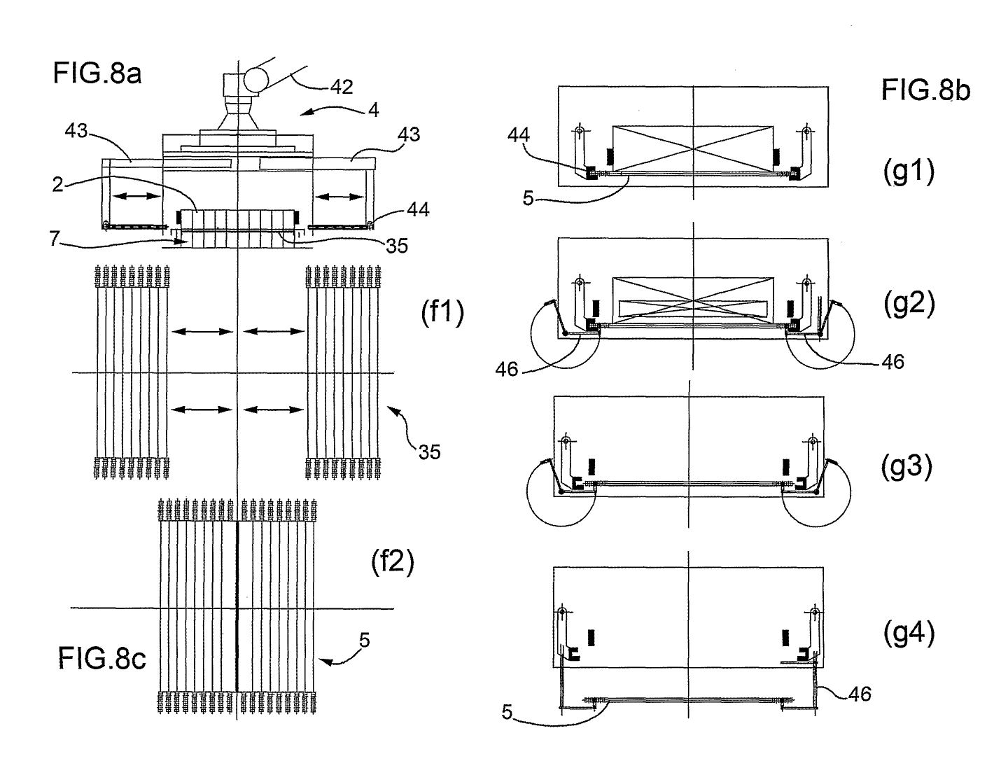

a pick-up head for picking up the layers from the release station and forming a palletized load of layers one on top of the other (FIG. 8).

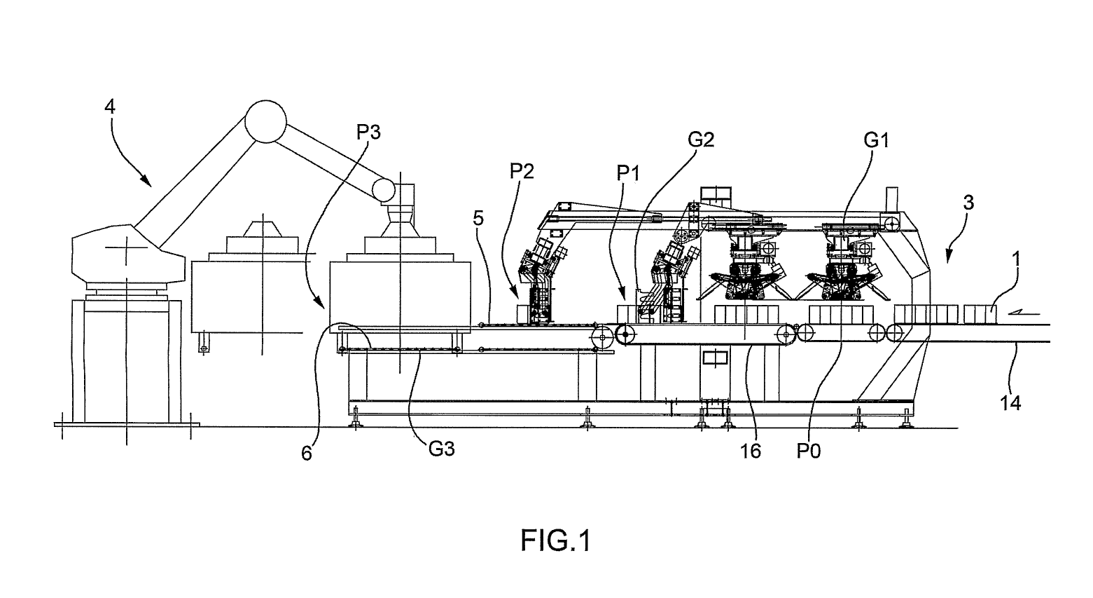

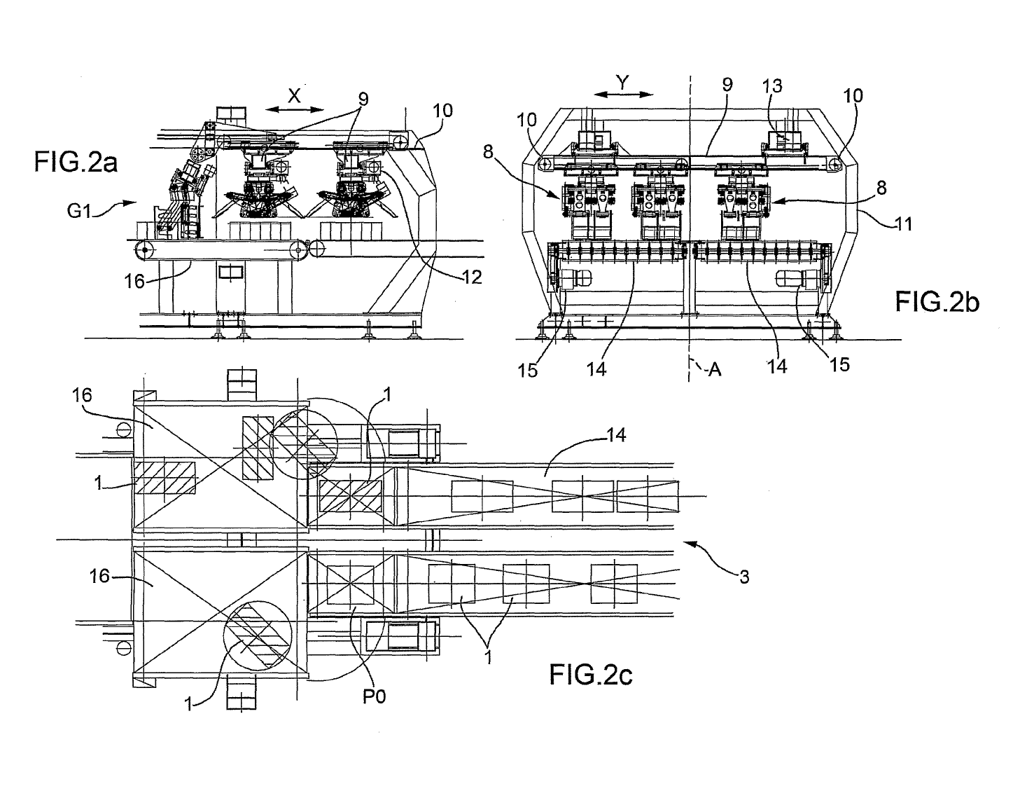

FIGS. 1, 2a and 2c show a transfer unit G1 comprising two gripper arms 8 supported by a frame 11 preferably of the gantry type and equipped with a cross-type movement in the longitudinal direction X and the crossways direction Y.

In particular, the arms 8 are mounted on their respective cross-beams 9 so that they can run in the crossways direction Y driven by suitable motor units

In particular, the arms 8 are mounted on their respective cross-beams 9 so that they can run in the crossways direction Y driven by suitable motor units 12 and where the cross-beams 9 in turn travel in the direction X being mounted on longitudinal guides 10 of the frame 11 driven by second motor units 13.

In the embodiment described, the packs are fed from an infeed line 3 comprising two belts 14 driven by motor units 15 and fitted with a dosing device which separates the packs 1 as they arrive and positions them at a fixed point PO ready to be picked up by the arms 8.

The arms 8 at the fixed point P0 receive the stopped packs (individually or in pairs) and transports them in one or both of the directions X and Y (and rotates them where required) until they are carried onto a conveyor belt 16 which then carries the packs without sliding into the position P1.

In the preferred embodiment, the pick-up and release of the packs on the transfer unit G1 is performed by grippers 81, with a pneumatically controlled opening and closing movement which does not raise the packs.

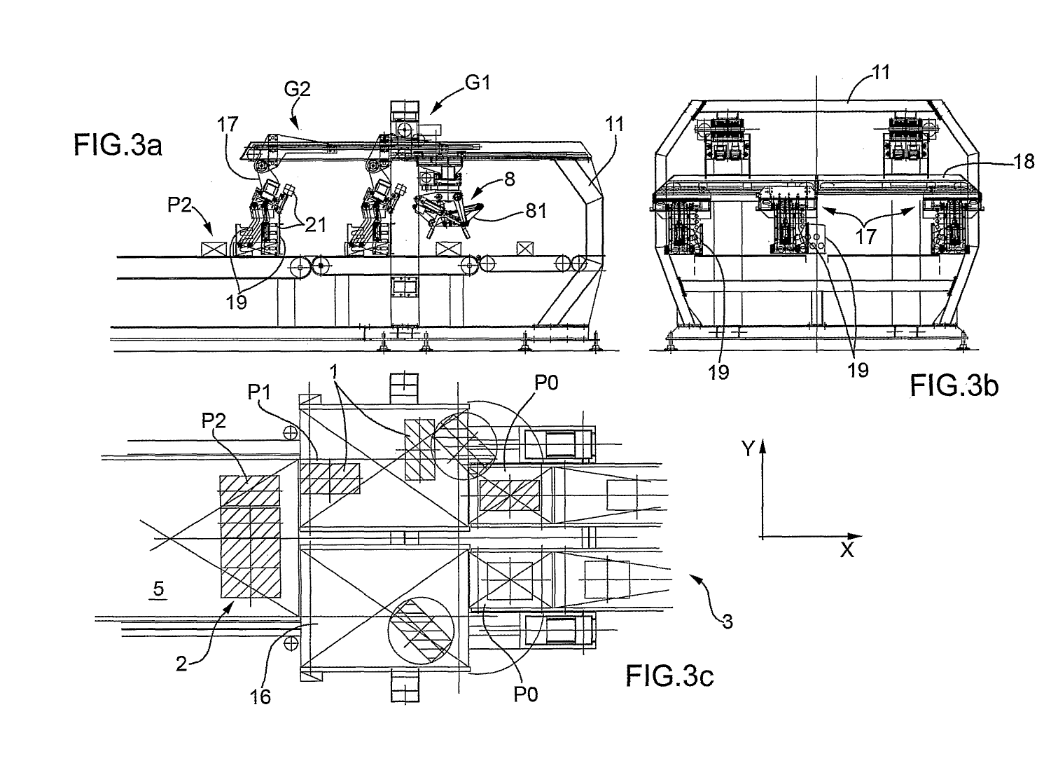

FIGS. 3a, 3b and 3c show a forming unit G2 comprising one or more arms 17 mounted on their respective cross-beams 18 of the frame 11 to enable travel, in the crossways direction Y, of the cross-beams 18 which in turn travel in the direction X being mounted on the longitudinal guides 20 of the frame 11.

The arms 17 are fitted with pusher plates 19 which make contact with the sides of the packs 1 and push them from position P1 to the final position P2 in the layer of packs 2 being formed on the loading platform 5.

In a preferred embodiment, the plates 19 are mobile and are moved in a horizontal direction by actuators 21 and are independent of each other so that they can adapt to the shape of the packs to be transferred.

During operation, the packs 1 are transferred by traversing them in one or both of the directions X, Y until they occupy position P2 which corresponds to the palletizing configuration required.

Advantageously, the absence of any gripper action holding the packs 1 enables the pusher arms 17 to return immediately to the pick-up position and therefore also reduces the operating time required.

Furthermore, with this solution the packs which have to be transferred onto the platform 5 are moved close to each other during the transfer by a composer unit thereby eliminating the need for side aligners which could otherwise cause jamming.

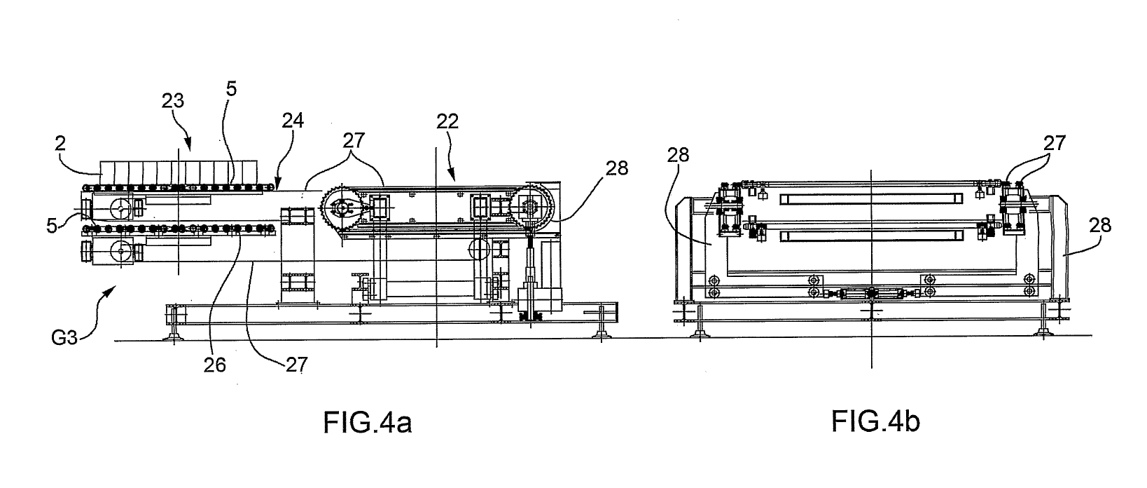

FIGS. 4a and 4b shows a loading unit G3 according to the present invention for transferring the formed layers 2 to the release station 6.

The loading unit G3 is designed to enable direct palletizing of the layers formed on the platform 5, without the need for intermediate steps or transfers.

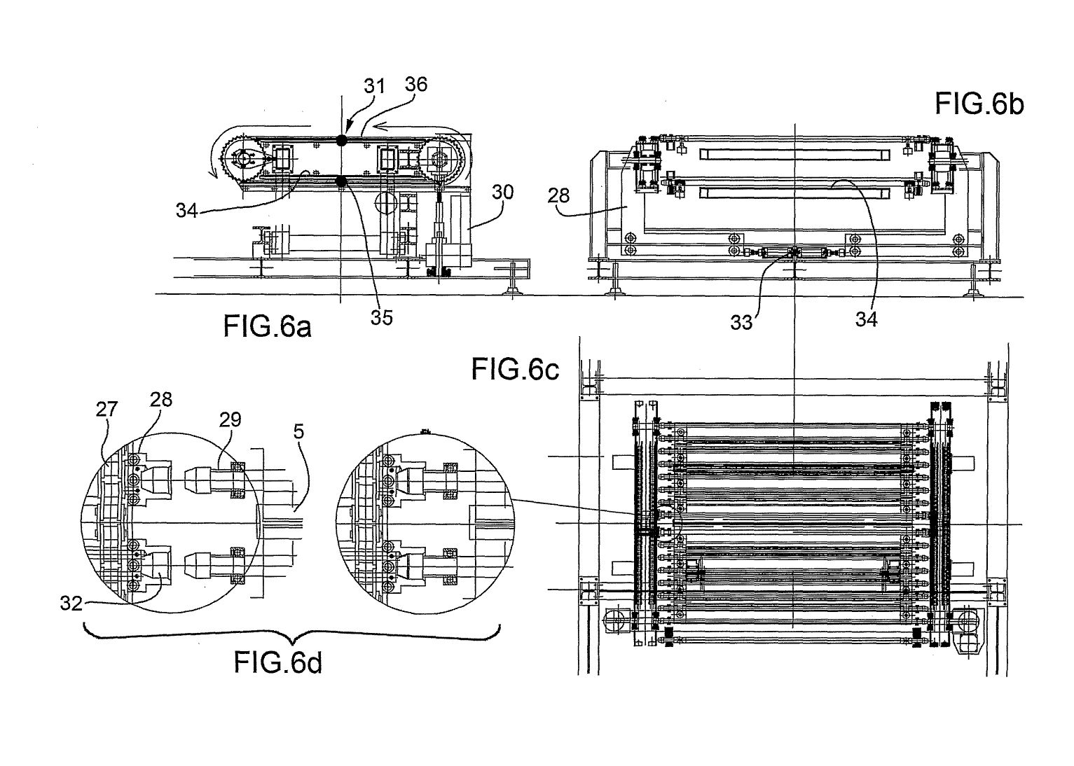

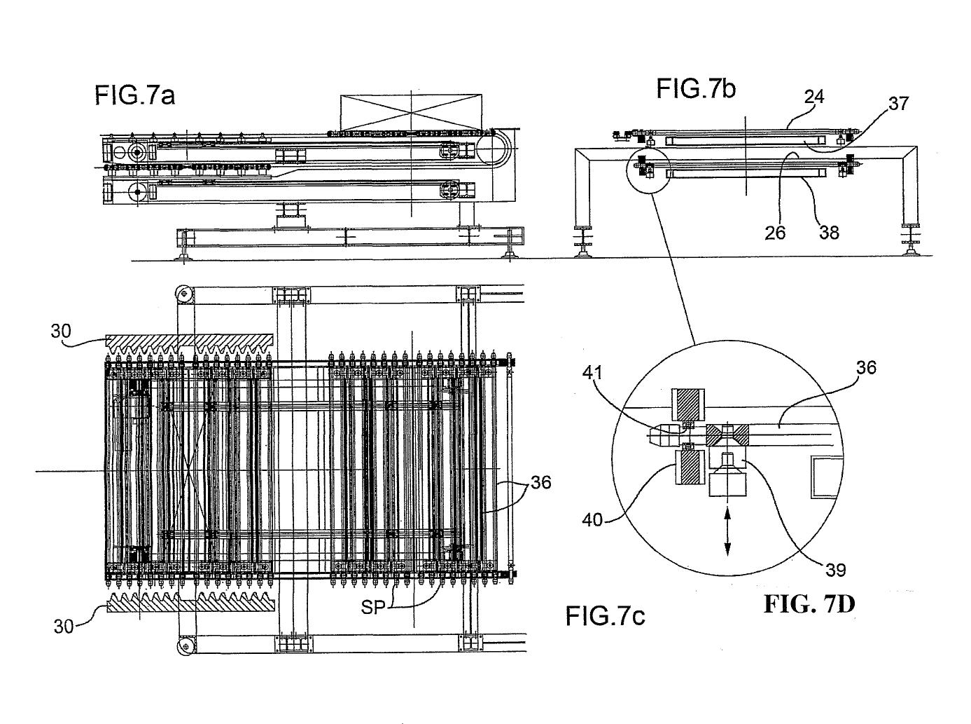

For this purpose, the loading unit G3, in the preferred embodiment described, comprises a programming unit 22 (shown in greater detail in FIGS. 6a to 6d) and a loading unit 23 (FIGS. 7a to 7d) which act together to move the platform 5 from the layer forming position P2 to the formed layer release position P3.

In particular, the units 22 and 23 comprise a recirculating chain which at the top enables the passage of the loaded platform 5 and at the bottom enables the return to the position P2 of the unloaded platform ready for the forming of the new layer.

In more detail, the loading unit G3 comprises three platforms 5, an unloaded platform used for feed purposes, a platform used for layer forming and a platform loaded with the already formed layer 2, where each platform comprises a pair of platform halves or flexible slats 35 comprising an arrangement of jointed, crossways rods.

During operation, the programming unit 22 engages the side of the platform 5, present on the lower surface 34, which should be loaded from the forming units G2, and then from the lower hooking point 35 feeds it forwards and upwards to the release point 31 on the upper surface 36 (FIG. 6a).

During this movement of the platform caused by the programming unit 22, the next rows of the layer 2 are formed. When the layer 2 is complete, the position of the last row in the completed layer is in the release position 31.

During this step, the loading unit 23 receives the platform 5 on the upper traversing surface 24, while the programmer hooking means detach from the platform 5 and move onto the lower hooking surface to hook the unloaded platform 5 or to wait for the arrival of an unloaded platform 5.

In a preferred embodiment, the programming unit 22 comprises two side drive chains 27 whose trajectory corresponds to the path followed by the platform 5 and where the hooking and unhooking movement is obtained by a control 33 controlling the sideways movement of the bands 28 which contain the chains 27 so that as the chains move away from the sides or move towards the sides they respectively disengage and engage the hook seats 32 of the corresponding pins 29 of the platforms 5 (FIGS. 6c to 6d).

Advantageously, the chain drives 30 are brushless motors synchronized with the operation of the forming units G2.

FIGS. 7a to 7d show the unit 23 of the loading unit G3 comprising two traversing surfaces, an upper surface 24 and a lower surface 26, along which drive carriages 37, 38 travel and which are fitted with retractable cones 39 which can engage with the rods 36 of the platforms 5 during traversing (FIG. 7d).

The upper surface 24 of the loader extends from the programmer release point 31 to the pick-up point P3 from which the loaded platforms 5 are moved for palletizing. In one embodiment of the present invention, there are at least three platforms 5.

During the operating cycle, the unloaded platforms are fed to the lower surface 26 by the palletizing robot. On the lower surface 26 a centering device 39 correctly positions the platform which is then hooked by the cones 39 of the lower carriage 38 and carried to the hooking point 35 of the programming unit 22 where it is received by the chains 27.

Before the chains 27 convey the platform 5 along the path already described, the cones 39 travel downwards and the lower carriage 38 returns to wait for a new unloaded platform.

The upper surface 24 is in turn provided with a carriage 37 similar to carriage 38 and is fitted with cones 39 which convey the platform from the release point 31 to the pick-up point P3 from where, once the layer 2 and the platform 5 have been delivered to the palletizing robot, the carriage 37 can return to the release point for a new cycle.

In a preferred embodiment, the platforms 5 are guided at the sides by linear cams 40 which engage with the bearings 41 mounted on the rods 36 in order to limit friction under load.

FIGS. 8a, 8b and 8c, show the operation of the pick-up head 4 according to the present invention when maneuvered by the palletizing robot 42. The head 4 is fitted with a pair of sliding side frames 43 fitted in turn with hooking points 44 engaging with the rods 36 of the half-platforms or slats 35.

The frames 43 are mobile and move away from and towards each other (FIG. 8c) to open the pair of slats 35 and release the layer 2 onto the palletized load 7 underneath and perform an opening cycle to unload (f1) and a closing cycle (f2) to prepare for a new load.

FIG. 8b shows the succession of movements of the hooking points 44 which, starting from the loading step (g1) and once the layer 2 loading has been completed (g2), open to disengage the platform 5 which is then engaged by the mechanism 46 (g3) to be carried to the lower level (g4) at the point where the platform 5 is returned to the lower surface 26 of the loader 23.

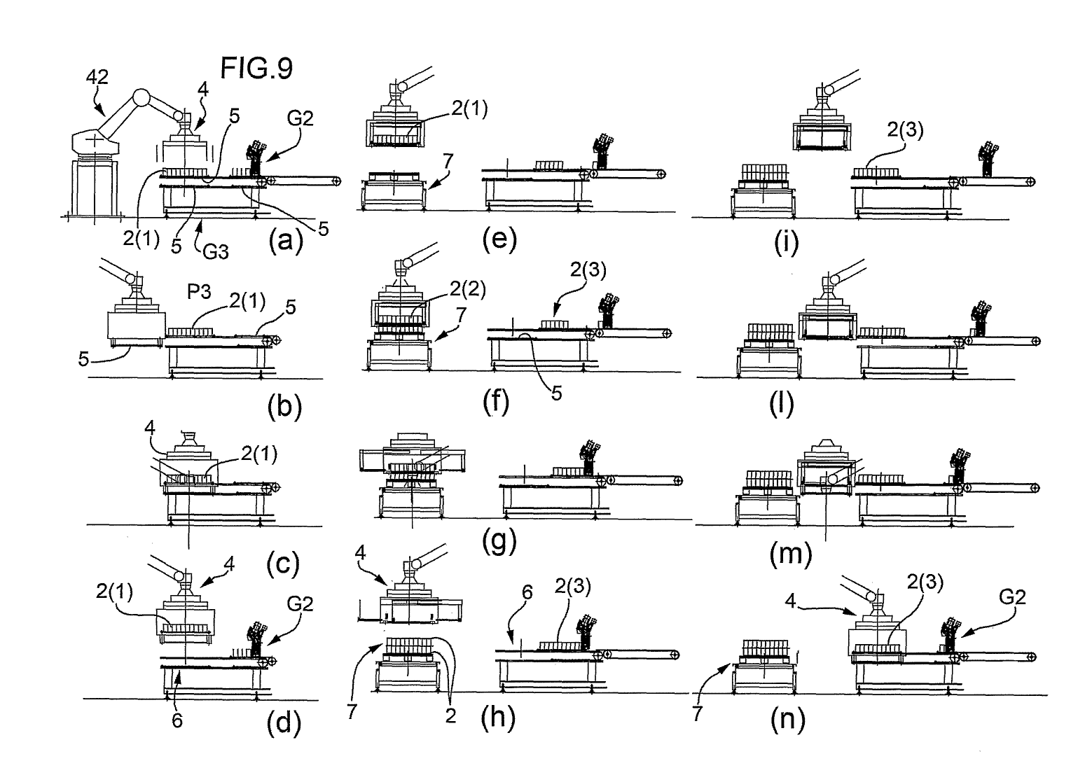

The steps of the operating cycle are clearly shown in FIG. 9. The figure shows the various operating cycle steps (a to n) of the palletizing equipment.

FIG. 9(a) shows the entire palletizing zone in a standard operating condition.

There is a platform 5 complete with a formed layer 2(1) of product. The head 4 is above the layer while a second platform is delivering to the programming unit 22 which is synchronized with the forming unit G2 which forms the rows for the new layer. A third platform 5 has just been returned by the head 4 to the lower level 26 of the loading unit G3.

FIG. 9(b)

The layer 2(1) is at the pick-up point. The platform on the pallet is on the approaching pick-up head 4 and the programmer starts to feed the platform forward for the loading of a new layer.

FIG. 9(c)

The head returns the empty platform and picks up the second layer 2(2).

FIG. 9(d)

The head 4 starts the transfer movement towards the pallet (not shown), the forming unit G2 starts to form the rows of a layer 2.

FIG. 9(e)

The layer 2(1) is loaded onto the pallet, the unloaded platform 5 waits at the lower return point.

FIGS. 9(f) and 9(g)

The head unloads the second layer onto the pallet while the third layer 2(3) is being formed and a platform is positioned and centered on the lower return point.

FIGS. 9(h) and 9(i)

The head has deposited the second layer 2(2) and starts to pick up the third layer 2(3) which has been completed and transferred by the loader from the programmer release point to the pick-up point.

FIGS. 9(l) and 9(n)

The head 4 returns the empty platform and picks up the third layer 2(3) while the forming unit forms the fourth layer.

The invention described above has a series of major advantages.

One advantage comprises of the idea of forming the layers and transferring the packs in the static mode without impacting the packs with deviators or similar devices. This limits any possible damage.

In particular, the packs are picked up in the positive mode by the grippers and placed in the active mode to form the layers of the pallet being formed.

A further advantageous aspect of the invention comprises its positioning accuracy and in the fact that corrective actions such as aligning are not required.

A further advantageous aspect comprises the possibility of being able to synchronize and control with precision the various steps in the cycle for transferring the single packs and thereby achieve high levels of productivity and flexibility.

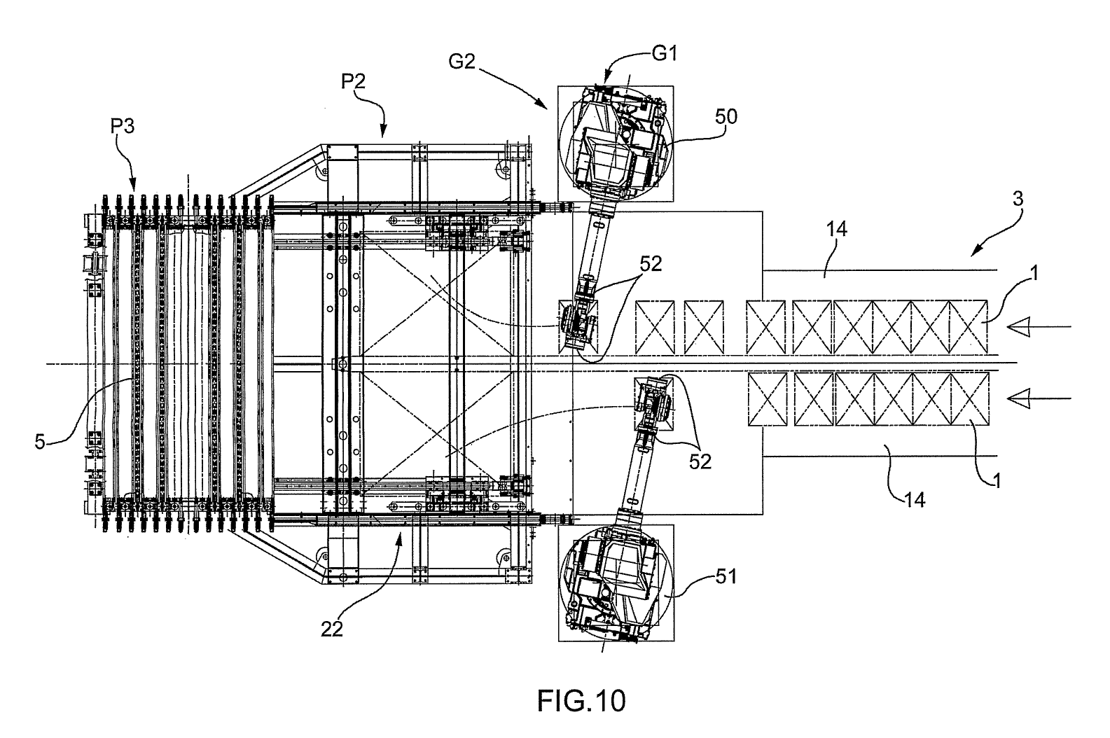

FIG. 10 shows a plan view of a further embodiment of the palletizer machine according to the present invention.

It should be noted that in the figures and description of this further embodiment and the other embodiments which follow, the reference numbers used are wherever possible the same as those used in the description of the previous embodiment to indicate the parts and characteristics of the present invention.

In this embodiment the palletizer machine comprises a loading unit G3 which has larger crossways dimensions than the machine in the previous embodiment so that it can form larger layers 2 composed of a greater number of packs 1. As a consequence the loading platforms 5 have larger crossways dimensions than those of the previous embodiment.

In this embodiment of the palletizer machine, the transfer unit G1 and the forming unit G2 comprise two manipulator robots 50, 51, right and left respectively, positioned on opposite sides of the infeed transfer line 3, which transfer and orient the packs 1 arriving respectively from the two belts 14 of the infeed line 3 at the loading position P2, so as to form layers 2 of packs 1 on a loading platform 5.

In particular, the two manipulator robots 50, 51 are controlled and operated by the palletizer machine controller and are each equipped with counteropposing grippers 52 designed to grip the sides of the packs 1; during operation, the two manipulator robots right and left 50, 51 pick up, one at a time, the packs 1 conveyed by the two belts 14, right and left respectively from the infeed line 3 and deposit them in the loading position P2 according to the preset sequence for forming the layers 2. In practice, each of the manipulator robots 50, 51 forms its corresponding half-layer 2, right and left, without interfering with the operation of the other manipulator.

As FIG. 10 shows, the two manipulator robots 50, 51 transfer the packs 1 from the belts 14 to the loading position P2 according to rotary trajectories which depend on various factors such as the dimensions of the packs 1, the final dimensions of the layers 2 to be formed, the position and orientation of the single packs 1 inside each layer 2.

This embodiment enables particularly high production speeds due to the presence of the two robot units operating in parallel given that the manipulator robots 50, 51 each operate with pack handling times which are shorter than those of pack transfer and layer forming units used in other technical solutions such as the gantry type robot described for the previous embodiment.

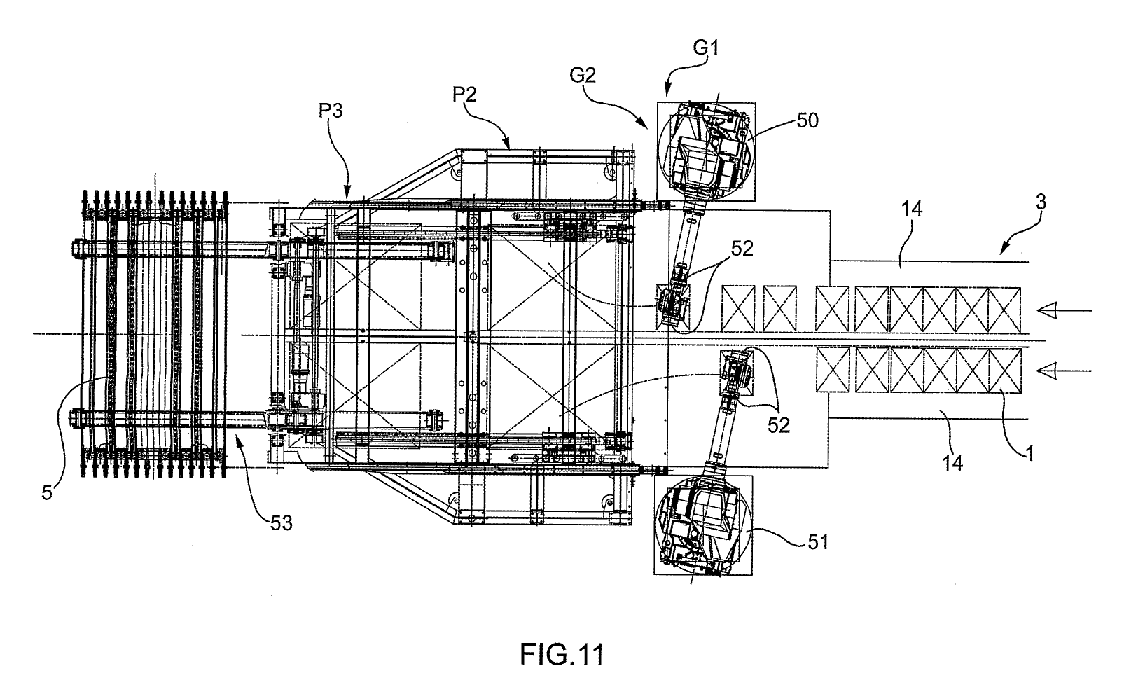

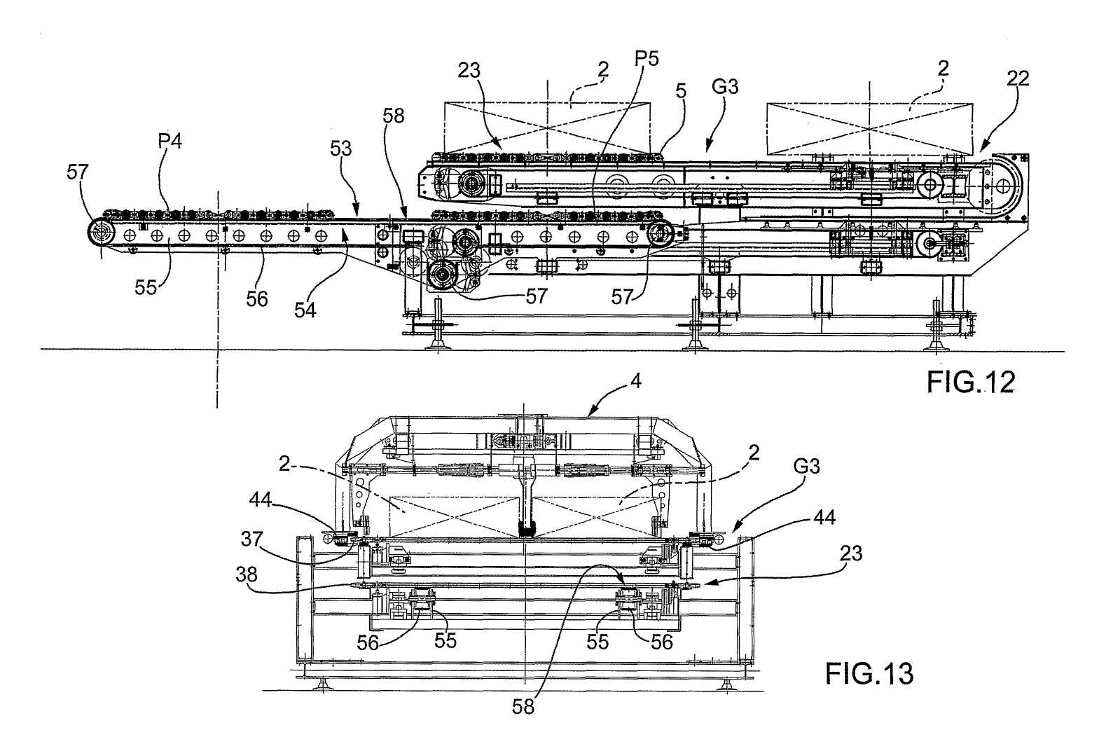

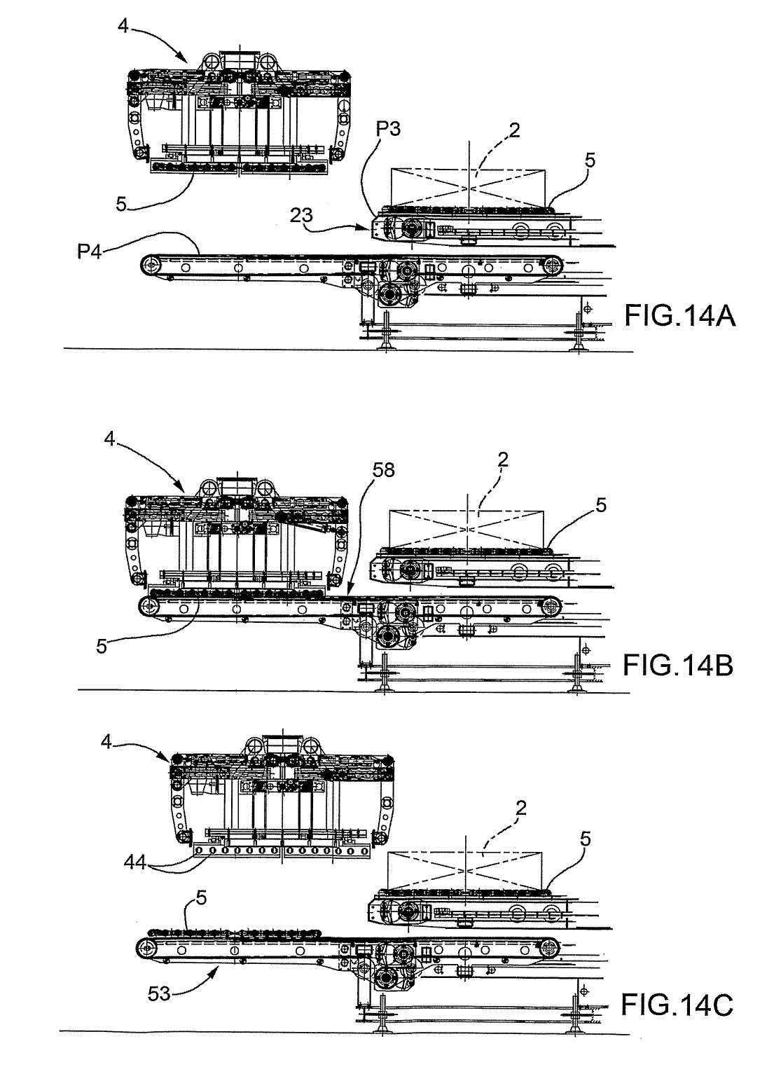

A further embodiment of the palletizer machine according to the present invention is shown in FIGS. 11 to 13 and FIGS. 14A to 14F.

This embodiment comprises a transfer unit G1 and a forming unit G2 which together, like the embodiment described previously for FIG. 11, comprise two manipulator robots 50, 51, right and left respectively, designed to pick up the packs 1 from the infeed line 3 and transfer them in an ordered way to the loading position P2 on a platform 5 to form a single layer 2 of packs 1.

In this particular embodiment the palletizer machine also comprises a receiver module 53 for the empty platform 5 to be returned to the lower surface 26 of the loading unit 23, as described in more detail below.

The receiver module 53 is linked to the loading unit G3, as described for the previous embodiments, and comprises a frame, indicated in its entirety by the numeral 54, solidly attached to the frame of the loading unit G3. The frame 54 of the receiver module 53 comprises two lengthways members 55 positioned below the loading unit G3 and are offset longitudinally with respect to the loading unit so that their center line is substantially close to the end of the pick-up point P3 of the platform 5 holding a layer 2 of packs 1, as clearly shown in FIG. 12.

The two lengthways members 55 support corresponding rotary belts 56 running around pulleys 57 which are equipped with actuating means comprising an electric motor of the known, conventional type which is therefore not shown in the figures also for reasons of simplicity.

The upper sections of the belts 56 define a mobile support surface 58 designed to directly receive each empty platform 5 unloaded by the pick-up head 4 at each palletizer machine cycle and to deliver the platform to the lower conveying surface 26 of the loading unit 23 of the loading unit G3. In particular, the belts 56 are coated with a high-friction material to convey the platform from the unloading position P4 of the pick-up head 4, at the free end of the receiver module 53, to the delivery position P5 of the platform 5 of the loading unit 23 of the loading unit G3; the position P5 is defined by the innermost end of the receiver module, in other words by the end substantially underneath the loading unit 23. The centering device 30 ensures correct positioning before pickup by the lower carriage 38.

Additionally, the palletizer machine in the present embodiment has a simplified pick-up head 4, that is, one without the mechanism 46 described for the first embodiment, to carry each empty platform 5 to the lower surface corresponding to measurement for returning the platform 5 to the lower surface 26 of the loader 23, for reasons to be described in detail below.

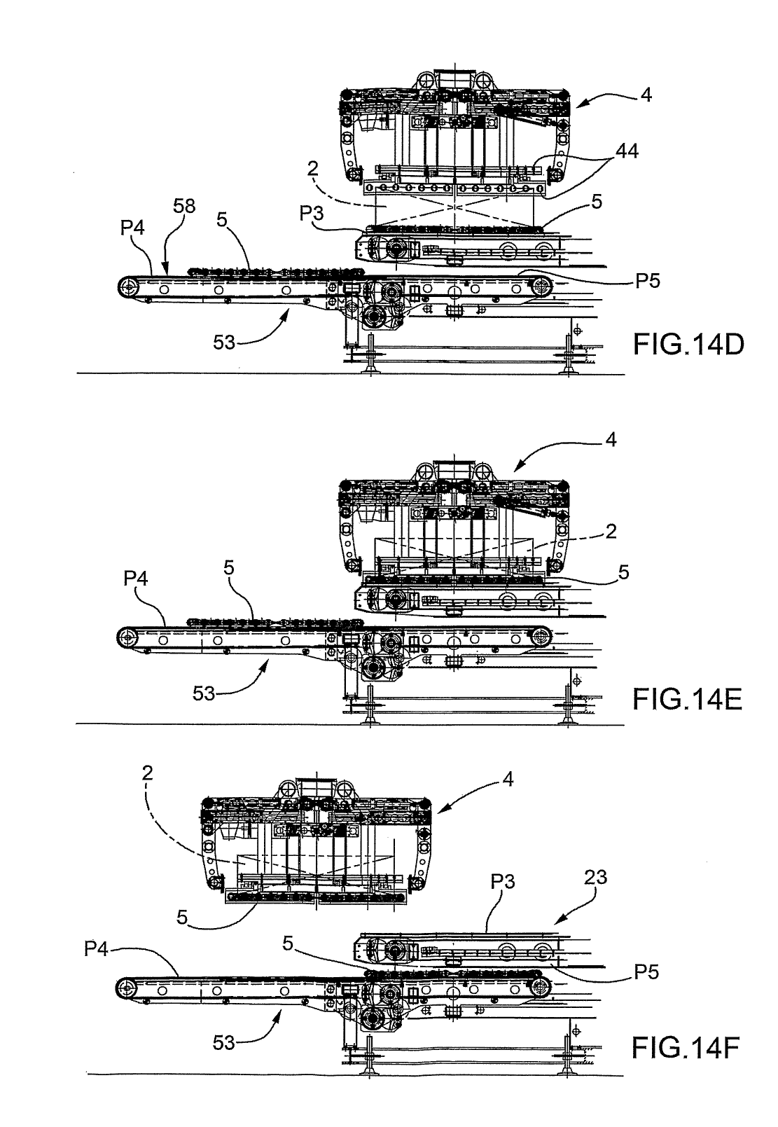

The operating cycle of the palletizer machine in the present embodiment, with particular reference to the receiver module 53 is described below; as an aid to understanding the description which follows reference should be made to FIGS. 14A to 14F which show the main steps of the operating cycle.

FIG. 14A shows a step of the palletizer machine operating cycle where the pick-up head 4, which has just unloaded the layer 2 of packs 1 on the pallet, approaches the receiver module 53, moving into position above the unloading position P4. At the same time, a layer 2 of packs ready to be picked up is on its platform 5, at the pick-up point P3 of the loader 23.

In the next step, shown in FIG. 14B, the pick-up head 4 travels downwards vertically to reach the unloading position P4 of the receiver module 53 and, when the hooking points 44 move apart from each other, deposits the empty platform 5 on the mobile support surface 58 defined by the belts 56.

In the next step, shown in FIG. 14C, the pick-up head 4, having left the platform 5 in the unloading position P4 of the receiver module 53, starts to travel towards the pick-up point P3 for the layer 2 of packs 1 and its corresponding platform 5 currently waiting to be picked up.

FIG. 14D shows the next step in the operating cycle where the pick-up head 4 travels to a position above the pick-up point P3 ready to pick up the layer 2 with its corresponding platform 5. At the same time the empty platform 5 unloaded at the unloading point (P4), thanks to the action of the belts 56 of the receiver module 53, starts to travel horizontally towards the delivery position P5.

Next, as shown in FIG. 14E, the pick-up head 4 travels downwards vertically so that its hooking points 44 engage both sides of the platform 5 with the layer 2. The unloaded platform 5, on the other hand, continues its travel towards the delivery position P5.

In the next step, shown in FIG. 14F, the pick-up head 4 which has engaged the platform 5 holding the layer 2, travels towards the pallet where it deposits the layer 2; at the same time, the empty platform 5 travels towards and reaches the delivery position P5. Next, the unloaded plate 5 travels from this position and is positioned on the lower surface 26 of the loader 23 to be handled by the centering device 30 ready to be returned to the work cycle at the right time, or in other words, ready for the forming of a new layer 2 of packs 1.

This particular embodiment has further major technical advantages.

Firstly, as described above, the pick-up head 4 of this embodiment does not have any type of mechanism 46 for lowering the empty platforms 5 to the lower surface 26 of the loader 23. This feature clearly makes the pick-up head 4 lighter and also easier to manufacture since it does not have a series of mechanical components and related actuators. This is a technical advantage not only in economic and manufacturing terms but also in terms of the control of production since it is easier to handle pack layers of larger dimensions at higher production speeds.

As already described, eliminating the mechanism 46 in this way is made possible by fitting a receiver module 53 which substitutes the function of the mechanism for recovering the unloaded platforms 5 and returning them to the production cycle. In effect, the pick-up head 4, rather than inserting the empty platform 5 in the lower surface 26 of the loader by means of the mechanism 46, deposits it directly on top of the receiver module 53 which then transfers it to the loader 23 to restart the cycle.

A further important advantage is that this embodiment eliminates the downtimes in the production cycle characteristic of the embodiments described earlier. In effect, the pick-up head 4, thanks to the presence of the receiver module 53, does not have to wait for the loader 23 to be ready to receive an empty platform 5, that is, it does not have to wait for the arrival of the lower drive carriage, but can simply unload the platform into the unloading position P4 and then continue on immediately to pick up the next layer 2 from the pick-up point P3 of the loader 23.

In this way the receiver module 53 acts as a buffer magazine of empty platforms 5 so as to match the operating times of the pick-up head 4 and the loader 23 and thereby reduce downtimes to the minimum.

Advantageously, the presence of the receiver module 53 makes it possible to add another platform for the forming of layers 2 of packs 1 to the production cycle thus increasing the number of platforms 5 present in the palletizer machine from three to four. This enables a considerable increase in the production capacity of the palletizer machine in terms of the number of pallets processed in a particular time period.

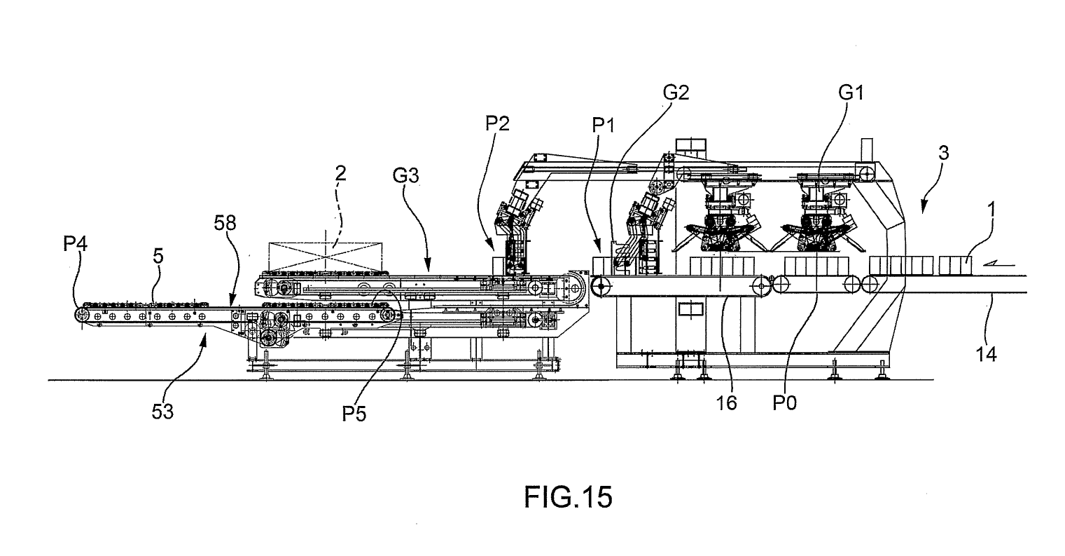

A further embodiment of the palletizer machine according to the present invention is shown in FIG. 15.

This embodiment comprises a transfer unit G1 and a forming unit G2 similar to those present in the first embodiment described above, and a loading unit G3 equipped with a receiver module 53 as described in the previous embodiment. This solution makes it possible to optimize operating times and to increase the number of active platforms also in palletizer machines in packing plant with lower production capacities.

Clearly, the present invention is not limited to the embodiments illustrated and described herein and is susceptible to numerous modifications and variants without thereby departing from the scope of the inventive concept as described, illustrated and disclosed herein.

1-29. (canceled)

30. A palletizer machine for layers, one on top of the other, of packs fed from a infeed transfer line, comprising:
a transfer unit for transferring and orienting packs arriving from an infeed line to a first static operating position,
a forming unit for feeding single packs from the position to a forming position for forming a layer of packs on a loading platform,
a loading group for transferring a formed layer on a loading platform to a pick-up station,
means for picking up the layer from the pick-up station and forming a palletized load of layers one on top of the other.

31. The palletizer machine according to claim 30, wherein the loading group comprises a programming unit synchronized with the forming unit to form on empty platforms successive rows of layers of packs and a loading unit for moving the loaded platforms from the release point of the programming unit to the pick-up position of the formed layer, and for moving the empty platforms from a return point to a hooking point of the programming unit.

32. The palletizer machine according to claim 31, comprising a receiver module fitted to the loading group and designed to receive empty platforms from the means for picking up and transfer them to the loading unit.

33. The palletizer machine according to claim 32, wherein the receiver module comprises a frame, fitted to the loading group, comprising two lengthways members positioned below the loading group.

34. The palletizer machine according to claim 33, wherein the lengthways members are offset longitudinally with respect to the loading group, whereby their center line is substantially close to the end of the pick-up position of the platform holding a layer of packs.

35. The palletizer machine according to claim 34, wherein the lengthways members support corresponding rotary belts running around pulleys at least one of which is powered by a motor and wherein the belts define a mobile support surface designed to directly receive each empty platform unloaded by the means for picking up in an unloading position and deliver it to the loading unit of the loading group in a delivery position.

36. The palletizer machine according to claim 35, wherein the transfer unit and the forming unit comprise at least one manipulator robot for transferring and orienting the packs arriving from the infeed line at the forming position.

37. A palletizer machine for layers, one on top of the other, of packs fed from a infeed transfer line, comprising:
a transfer unit for transferring and orienting packs arriving from an infeed line to a first static operating position,
a forming unit for feeding single packs from the position to a forming position for forming a layer of packs on a loading platform,
a loading group for transferring a formed layer on a loading platform to a pick-up station,
means for picking up the layer from the pick-up station and forming a palletized load of layers one on top of the other, and
a programming unit synchronized with the forming unit to form on empty platforms successive rows of layers of packs and a loading unit for moving the loaded platforms from the release point of the programming unit to the pick-up position of the formed layer, and for moving the empty platforms from a return point to a hooking point of the programming unit, said programming unit including two side chains for driving the platforms, provided with a sideways movement for hooking/unhooking the platforms.

38. The palletizer machine according to claim 37, comprising a receiver module fitted to the loading group and designed to receive empty platforms from the means for picking up and transfer them to the loading unit.

39. The palletizer machine according to claim 37, wherein the loading unit of the loading group comprises means for driving the platforms along two traversing surfaces, an upper surface for driving the loaded platforms towards the pick-up position and a lower surface for returning the empty platforms towards the forming position.

40. The palletizer machine according to claim 37, wherein the loading unit comprises a centering device for correctly positioning the empty platforms returned to the surface.

41. The palletizer machine according to claim 40, wherein the means for driving of the loading unit comprise at least one carriage fitted with engaging/disengaging means for engaging and disengaging the platforms.

42. The palletizer machine according to claim 41, wherein the means for engaging/disengaging the platforms comprise at least one carriage fitted with cones with a movement controlled to engage and disengage the platforms.

43. The palletizer machine according to claim 42, wherein the transfer unit and the forming unit comprise at least one manipulator robot for transferring and orienting the packs arriving from the infeed line at the forming position.

44. A palletizer machine for layers, one on top of the other, of packs fed from a infeed transfer line, comprising:
a transfer unit for transferring and orienting packs arriving from an infeed line to a first static operating position,
a forming unit for feeding single packs from the position to a forming position for forming a layer of packs on a loading platform,
a loading group for transferring a formed layer on a loading platform to a pick-up station,
means for picking up the layer from the pick-up station and forming a palletized load of layers one on top of the other, said means for pick-up including a pick-up head fitted with a pair of side frames equipped with hooking points for the platform halves or slats forming the platform where the frames are mobile and move away from and towards each other to open and close the pair of slats in the steps for unloading and loading the layers.

45. The palletizer machine according to claim 44, wherein the means for picking up the layer comprise means for releasing the pair of slats on the layer forming position.

46. The palletizer machine according to claim 44, wherein the transfer unit and the forming unit comprise at least one manipulator robot for transferring and orienting the packs arriving from the infeed line at the forming position.

47. The palletizer machine according to claim 44, wherein the transfer unit and the forming unit comprise two manipulator robots each positioned on opposite sides of the infeed line, for transferring and orienting packs arriving from the infeed line at the forming position.

48. The palletizer machine according to claim 44, wherein the transfer unit comprises at least one gripper arm supported by a frame and equipped with a cross-type movement in the longitudinal direction and the crossways direction and a rotary movement.

49. The palletizer machine according to claim 44, wherein the transfer unit picks-up and releases packs by grippers without raising of the packs.

50. The palletizer machine according to claim 49, wherein the grippers act sideways on the two adjacent sides of the packs.

51. The palletizer machine according to claim 44, wherein the forming unit comprises one or more transfer arms mounted on their respective cross-beams of the frame in order to enable travel, in a crossways direction of the cross-beams which in turn travel in the longitudinal direction being mounted on the longitudinal guides of the frame.

52. The palletizer machine according to claim 51, wherein the arms are fitted with pusher plates which make contact with the sides of the packs and push them from position to the forming position in the layer of packs being formed on the loading platform.

53. The palletizer machine according to claim 52, wherein the plates are mobile and moved by actuators and are independent of each other.

54. A method of palletizing layers, one on top of the other, of packs fed from a infeed transfer line, comprising the following cycle steps:
transferring and orienting individual packs arriving from the infeed line at a first static operating position,
picking up individual packs from their stopped position and releasing the same packs to a forming position for fanning pack layers,
transferring the layers to a pick-up station,
forming a palletized load of layers one on top of the other.

55. The method according to claim 54, wherein the step for releasing individual packs in a forming position takes place on platforms.

56. The method according to claim 55, wherein the step for forming the palletized load takes place by dropping by means of the platforms with side opening.

57. The method according to claim 56, comprising a step for depositing the empty platforms in an unloading position.

58. The method according to claim 57, comprising a step for transferring the empty platforms to a delivery position.

59. The method according to claim 58, comprising a step for transferring the empty platforms to a forming position.

60. The method according to claim 54, wherein the steps for transferring and orienting the individual packs arriving from the line to a first static operating position and picking up individual stopped packs from the position and releasing them to a forming position to form layers of packs take place simultaneously.

61. The method according to claim 54, wherein the steps for picking-up and releasing packs in the transfer unit is performed by grippers without raising of the packs.

62. The method according to claim 61, wherein the steps for picking-up and releasing packs is performed by grippers acting sideways on the two adjacent sides of the packs.
